(19) United States
(12) Patent Application Publication
(10) Pub. No.: US 2016/0167316 A1
(43) Pub. Date: Jun. 16, 2016

(54) KEY TOOL AND COMPOSITE PANEL IN PARTICULAR FOR AN AIRCRAFT ENGINE NACELLE MANUFACTURED BY MEANS OF SUCH TOOL

(71) Applicant: AIRCELLE, GONFREVILLE L'ORCHER (FR)

(72) Inventors: Eric PILLON, GONFREVILLE L'ORCHER (FR); Christophe MAHU, OCTEVILLE/MER (FR); Denis GRENET, Les Trois Pierres (FR)

(73) Assignee: AIRCELLE, GONFREVILLE L'ORCHER (FR)

(21) Appl. No.: 15/049,497

(22) Filed: Feb. 22, 2016

Related U.S. Application Data
(63) Continuation of application No. PCT/FR2014/051989, filed on Jul. 30, 2014.

(30) Foreign Application Priority Data
Aug. 28, 2013 (FR) 13/58223

(51) Int. Cl. B29C 70/44; B29C 33/48; B29C 33/00

(52) U.S. Cl. CPC B29C 70/446; B29C 33/0038; B29C 33/485; B29L 2031/3076

(57) ABSTRACT

A key tool is provided that includes at least two keys having adjacent edges, the tool being substantially cylindrical in shape with a central axis, the adjacent edges being substantially parallel to the central axis. The adjacent edges have covers that are tangential relative to the inner and/or outer portions of the key tool. An application of the key tool is in the production of composite panels, in particular for an aircraft engine nacelle.

### CROSS-REFERENCE TO RELATED APPLICATIONS

This application is a continuation of International Application No. PCT/FR2014/051989, filed on Jul. 30, 3014, which claims the benefit of FR 13/58223, filed on Aug. 28, 2013. The disclosures of the above applications are incorporated herein by reference.

### FIELD

The present disclosure relates to a key tool a composite panel in particular for an aircraft engine nacelle manufactured by such a tool.

### BACKGROUND

The statements in this section merely provide background information related to the present disclosure and may not constitute prior art.

When a composite part extends over more than 180° of rotation and has a convex shape, a key tool is often used for manufacturing such a part. This tool has an outer shape corresponding to the inner shape of the part to be manufactured, and is formed of a plurality of sectors—or keys, which can be dismantled once the part is manufactured.

In practice, the manufacture of the part includes firstly a step of compaction of folds on the outer wall of the key tool, then a step of migration of the resin in the folds, and of polymerization of this resin.

These steps of compaction and migration of the resin, which is carried out under vacuum through an outer bladder which envelops the folds disposed on the key tool, include tight sealing of the seals between the different sectors of the key tool.

In practice, this sealing is obtained by means of a bladder internal to the tool, which is placed under vacuum in order to lie against the joint lines between the different sectors of the tool.

These joint lines are conventionally defined by radial returns of the various sectors forming the key tool, these returns being fastened together by bolts.

These returns therefore form protrusions inward the tool, which protrusions are likely to tear the inner bladder, and therefore to compromise the desired sealing.

### SUMMARY

The present disclosure includes a key tool in which the edges of the sectors have mutual contact surfaces which are circumferential, and in one form provided with seals.

Thanks to this particular arrangement, it is obtained a sealing allowing to pass from an inner bladder to the tool, or to only implement partial inner bladders covering only the joint line.

In one arrangement according to the present disclosure, there are no radial returns of the different sectors of the tool, so that in the case of the implementation of partial inner bladders, there is a reduced risk of tearing these bladders, as it was the case in the prior art.

To this end, the present disclosure concerns a key tool of the kind including at least two keys having adjacent edges, the tool having a substantially cylindrical shape with a central axis, the adjacent edges being substantially parallel to the central axis. According to the present disclosure, the adjacent edges have tangential overlaps relative to the inner and/or outer surface of the key tool.

According to other additional features of the present disclosure:

the tangential overlap of two adjacent edges of keys includes a thinning of a first edge of an inner side of the tool facing a thinning of a second edge of an outer side of the tool so that an extra thickness is not introduced on the inner and/or outer surface of the key tool;

the tangential overlapping portions of two adjacent edges cooperate with a seal;

at least one tangential overlap of adjacent edges of keys is covered by an inner and/or outer partial bladder, two seals substantially parallel to the central axis of the key tool being disposed on either side of said at least one tangential overlap between the inner and/or outer partial bladder and the inner and/or outer surface of the key tool;

an inner, respectively outer partial bladder cooperates with an outer, respectively inner bladder, by means of a return passing over the annular edge of the key tool and of a lug coming in contact with a seal on the surface facing a counterpart portion of said outer, respectively inner bladder;

a seal is disposed on an annular edge of the key tool so as to improve the sealing of an inner or outer partial bladder at its return;

the key tool cooperates with at least one inner, respectively outer partial bladder and an outer, respectively inner complete bladder;

the key tool cooperates only with an outer, respectively inner complete bladder;

keys are secured by bolt- or stud-type tangential connection means, and/or by a system for connecting and handling keys.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1a and 1b show a schematic view and a detail of the schematic view of a key tool with bladders according to the state of the art;

FIGS. 2a and 2b show a schematic view and a detail of the schematic view of a key tool with bladders according to a first form of the invention;

FIGS. 3a and 3b show a schematic view and a detail of the schematic view of a key tool with bladders according to a second form of the invention;

FIGS. 4a and 4b show perspective schematic views of tools according to another form of the present disclosure; and

FIG. 5 shows a partial sectional view of bladders used in the form of FIGS. 4a and 4b.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

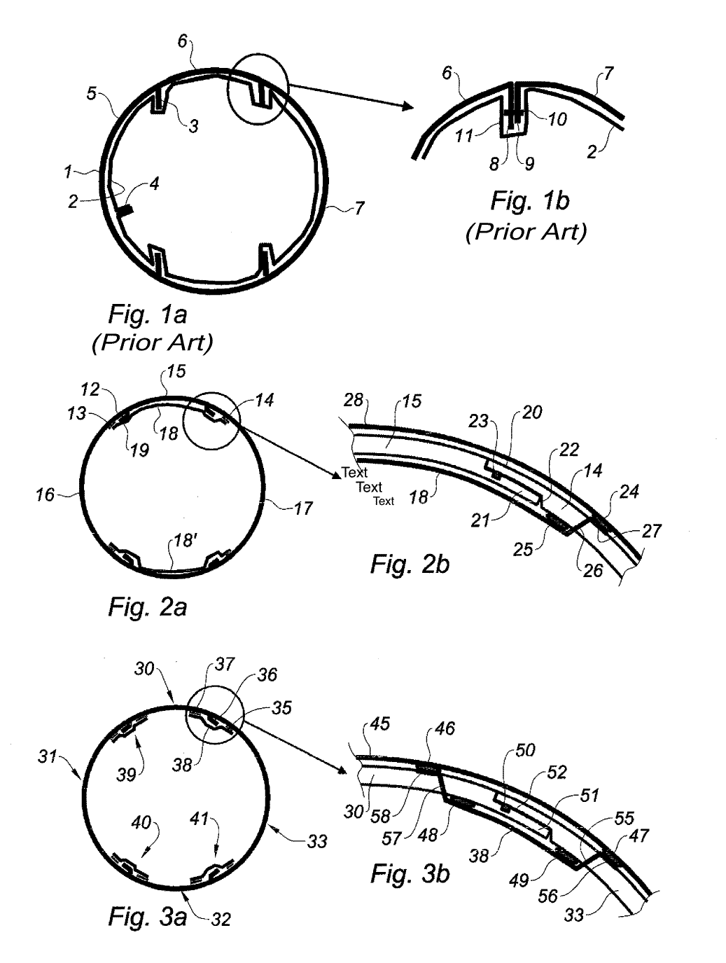

In FIG. 1a, it is shown a schematic view of a key tool with bladders according to the state of the art. The key tool 1 is viewed from above with an inner bladder 2. Of course, about the central axis of the substantially cylindrical-shaped key tool, shape variations are provided in the radial direction and which are not shown in order to simplify the drawing. Four sectors or keys such as the sectors 5, 6 and 7 are shown. Each sector 5, 6 or 7 is limited by a substantially radial return and directed inwardly of the tool. The radial returns such as the return 3, require that the inner bladder 2 has longitudinal pockets, along the central axis of the tool to surround as close as possible the inner surface of the tool.

In order to improve the sealing, as it has been shown in FIG. 1a on the return 4, the interval between two foldings of key edge (or sector) is filled with a seal.

In FIG. 1b, it is shown the detail of a radial return between the keys 6 and 7. The key 6 has a folded edge 8 which returns inwardly of the tool. The key 7 has a folded counterpart edge 9 which is disposed substantially parallel to the folded edge 8. A seal, as for the return 4 (FIG. 1a) may be inserted. Gradually connection means of radial edges such as the bolt 10 are disposed to secure the keys 6 and 7 on the radial return 8, 9. It is noted that the number may be high which makes the operations of mounting and dismantling of the key tool during the production long enough.

A sealing inner bladder 2 still is to be disposed on the inner surface of the key tool. Therefore, a pocket 11 is be formed to surround as close as possible the radial return 8, 9. However, during the pressurization or depressurization, during the setting up and the removal of the inner bladder 2, there is a high risk of tearing of the inner bladder on the radial returns.

In FIG. 2a, it is shown in a top view, a new disposition of key tool according to a first form of the present disclosure. In this form, the edges facing the keys are not oriented radially but substantially along the tangent to the inner surface of the key tool at the connection point between the two opposite keys. The tangential overlap of the edges of two adjacent keys is such that the edges of the sectors or keys have mutual contact surfaces which are circumferential relative to the central axis of the key tool.

A tool with four cylindrical keys or sectors is shown. Another number of keys, three to five for example, is provided.

In a first form, the edges of the keys are folded so as to reduce the extra thickness provided by the tangential returns formed by these folded edges. Their fastening may include the same kind of bolts as in the state of the art. The four keys of the tool have then four tangential returns such as the tangential return 12 between the keys. Due to the circumferential overlap of the opposite edges, this disposition will be designated as “tangential overlap” to indicate that the direction of the overlap is perpendicular to that of the state of the art.

It is then provided, not a single inner bladder overlying the entire inner surface of the key tool, but two inner partial bladders 18 and 18′, disposed within the smallest keys such as the key 15 and the two inner partial bladders covering a sector wide enough to cover the tangential overlaps of both sides of each “small” key, such as the key 15.

In the form shown in FIG. 2a (the same applying to FIG. 3a), the structure of each key is a “thin” structure, that is to say the thickness of which in the radial direction is not taken into account. The edges of the “thin” structures are then curved so that the bearing direction is substantially in a radial direction relative to the central axis of the key tool. It follows that the bearing of the adjacent edges is performed in frontal bearing when forces are applied on the key tool during its use for the manufacture of a composite panel including in particular, the compaction of the initial preform, and then its impregnation with resin.

It is noted that the tangential overlap 12 of the adjacent edges of the keys causes a moderate extra thickness on the inner surface of the tool so as the pocket 19 of the partial inner bladder 18 has a reduced height when compared to the height of the pockets of the single inner bladder of the state of the art (FIGS. 1a and 1b) in which the overlaps of the edges are radial and in which the bearings then work in shearing, which is not desirable.

Furthermore, the sharp portions of the radial return of the state of the art (FIG. 1a or 1b) no longer exist, since the edges of the keys are folded substantially along the local tangent to the inner surface of the key tool. The problem of tearing of the inner bladder is addressed, in particular because the radial return is eliminated and also because the inner bladder has been separated into two portions which can be more easily handled by an operator during the production steps of the composite panel.

Of course, it is possible to have more than two inner partial bladders such as the inner partial bladders 18 and 18′. For example, if only two keys are used to carry out the assembly of the key tool, including a small key, covering a narrow angular sector, for example of 60° and a large key, covering a wide angular sector, for example of 320°, then it is expected to have one single inner partial bladder covering the angular sector of the narrow key and going beyond so as to allow having, beyond the tangential overlaps of the key edges, adhesive sealing strips between the inner wall of the key and of the wall facing the inner partial bladder.

This disposition is illustrated in FIG. 2a for a form with four keys and two inner partial bladders. The inner partial bladder 18, disposed on the inner surface of the key 15 of small angular extent, extends beyond the tangential overlaps such as the tangential overlap 12, and the other tangential overlap without reference but on the key 15, of the other side of each of the tangential overlaps are disposed sealing adhesive strips 13 and 14. The seal 13 is disposed between the inner surface of the key 16 and the surface facing the partial bladder 18. The seal 14 is disposed between the inner surface of the key 17 and the surface facing the partial bladder 18.

Of course, the same dispositions are repeated on the second inner partial bladder 18′ and they are not recalled.

In FIG. 2b, it is shown a detail of a tool of the first form of FIG. 2a, but in which the tangential overlap is carried out by a particular conforming of the edges facing two successive keys and in which a sealing is disposed between the inner partial bladder and an outer bladder.

The two adjacent keys 14 and 15 are carried out of a thick structure, and they have edges intended to tangentially overlap in their thickness such that their overlap does not introduce any extra thickness on the inner surface of the key tool when the keys are assembled and secured by means of removable securing means of keys of key tool.

In another form, the counterpart edges of two adjacent keys are also shaped so as in their tangential overlap, extra thickness on the outer surface of the key tool is not introduced when the keys are assembled and secured by means of known removable securing means of keys of a key tool.

Thus in FIG. 2b, the edge of the right key 14 has a thinning 20 on the inside of the key tool in its thickness while the edge of the left key 15 has a thinning 21 on the outside of the key tool in its thickness. The thinned edges 20 and 21 are shaped so as their tangential overlap does not introduce extra thickness on the inner surface or the outer surface of the key tool.

In order to provide a guiding during the mounting of the key 15 from the inside of the key tool on the key 14 and on the other key (not visible from the other side of the key 15) the counterpart edge has, to the right of the thinning 20, a chamfer 22 which provides guiding of the tip of the thinning 21 of the counterpart edge of the key 15.

In order to provide sealing between the inner volume limited between the inner partial bladder 18 and the inner surface of the key tool, in line with the tangential overlap 20, 21, a seal 23 is disposed and is engaged in an elongated groove parallel to the central axis of the key tool. The groove is disposed along the thinning 21 of the right edge of the key facing the thinning 20 of the left edge of the key 14. The seal 23 is disposed over the entire height of the key tool in the direction of the central axis of the key tool.

An outer bladder 28, partially shown in FIG. 2b, completely surrounds the outer surface of the key tool beyond the keys 14 and 15. The view of FIG. 2b being a top view, it is schematically shown a return 26 of the inner partial bladder 18 which passes over the upper edge (not shown to allow the structure of the tangential overlap of the edges of the adjacent keys 14 and 15 to be viewed). The sealing between the inner partial bladder 18 and the outer bladder 28 is carried out in particular by means of a seal 24 performed between a flap 27 secured to the return 26 of the inner partial bladder 18 which passes over the upper edge of the key tool.

The sealing of the inner partial bladder 18 is completed with another seal placed between the inner partial bladder 19 and the inner surface of the key 14 near the right of the tangential overlap 20, 21.

Of course, the same dispositions, of sealing in particular, are performed on the left at the tangential overlap such as the tangential overlap 12 (FIG. 2a) on the other tangential overlap carried out between the left edge of the key 15 and the edge of the adjacent key on the left (not visible in FIG. 2b).

In FIG. 3a, it is shown another form of a key tool according to the present disclosure. It includes four keys 30-33 including two narrow keys 30 and 32. The four keys are joined by four tangential overlaps each covered by its own inner partial bladder 38-41. Each inner partial bladder such as the bladder 38 is associated with the inner surface of the key tool by means of seals 35 and 37 on either side of the tangential overlap 36. As in the form of FIG. 2a, the inner partial bladders 38-41 have an extension along the central axis of the substantially cylindrical-shaped key tool and the seals such as the seals 35 and 37 on either side of the tangential overlap 36 of the edges of keys are substantially lined up on generators of this substantially cylindrical shape.

In FIG. 3b, which shows a detail of the interface between the keys 30 and 33 of the key tool of FIG. 3a, it is shown a particular form of a tangential overlap of the edges of adjacent keys such as in the case of FIG. 2b. The adjacent edges have a thinning 51 on the key 30 and a thinning 52 on the key 33 so as an extra thickness does not appear either on the inner surface or on the outer surface of the key tool. A seal 50 is disposed between the two thinnings 51 and 52 such as the seal 23 of the form of FIG. 2b.

In the form of FIG. 3b, the inner partial bladder 38 has two seals 48 and 49 on either side of the tangential overlap 51, 52 and disposed on the inner surface of the key tool according to generators of its substantially cylindrical shape.

On the upper portion of the inner partial bladder 38, it is disposed inner partial bladder returns 57 and 55 which are joined with the flaps 58 and 56 which are intended to come on seals 46 and 47 placed between the lug of the inner partial bladder and the inner surface of an outer bladder 28.

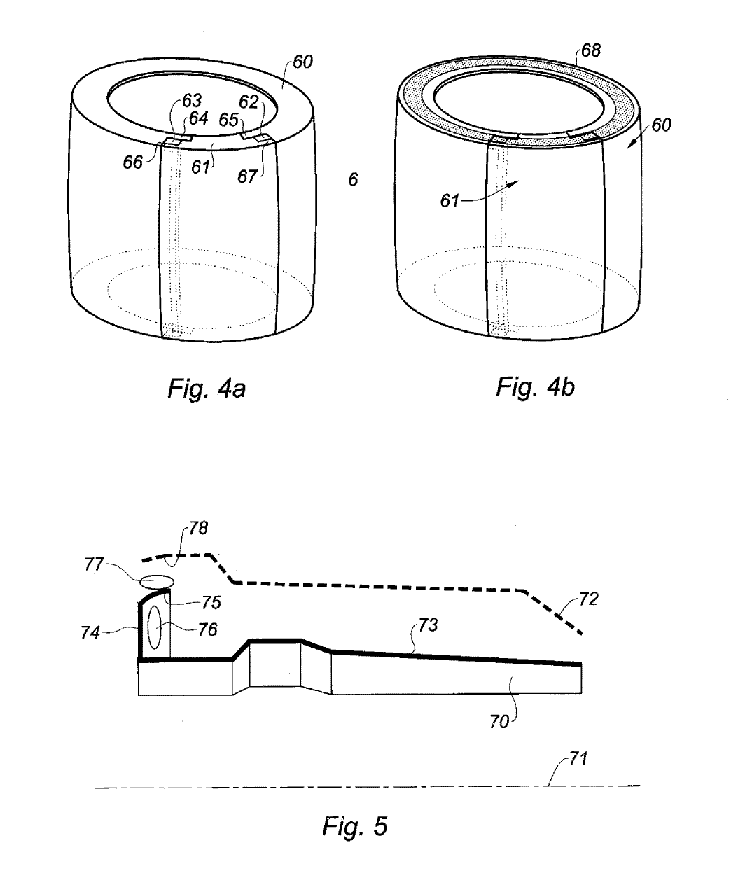

In FIG. 4a, it is shown one form of a key tool including two keys 60 and 61. The key 61 has an angular extension about the central axis of the key tool smaller than the angular extension of the key 60. The tangential overlap of the adjacent edges resumes the technique of the thinnings described in FIGS. 2a and 2b. Thus the key 61 has thinnings 66 and 67 on its two edges which are disposed on the side of the outer surface of the key tool, while the key 60 has thinnings 64 and 657 on its two edges which are disposed on the side of the inner surface of the key tool. Elongated seals 63 and 62 are disposed between the counterpart thinnings of the tangential overlapping edges as it has been described hereinabove.

In FIG. 4b, it is disposed a seal 68 disposed over the entire upper ring forming the upper edge of the key tool. The seal 68 is used to carry out a sealing between the inner and outer bladders through their returns as it has been described in FIGS. 2b and 3b.

In FIG. 5, it is shown a schematic sectional view of an inner partial bladder 70 according to the present disclosure by a radial plane containing the central axis 71 of the key tool. The key tool has not been shown in order to simplify the drawing. The position of the outer bladder 72 which, in the present disclosure, carries out the complete surround of the key tool beyond its outer surface has been shown in dashed lines. The key tool is of course disposed in the volume comprised between the inner partial bladder 70 and the outer bladder 72.

The inner partial bladder 70 has a complex generating line 73 rather parallel to the central axis 71 of the key tool. On the cylindrical shape thus generated, is joined an inner partial bladder 74 return which extends then by a lug 75. The inner partial bladder 74 return is intended to be applied on the upper edge of the key tool (see FIGS. 4a and 4b) by means of a seal 76 (counterpart of the seal 68; FIG. 4b). It carries finally a lug 75 which returns parallel to the inner surface of the outer bladder 72 to which it is connected by a seal 77 on a portion 78 configured for this purpose.

In one form, the key tool of the present disclosure contains three to five keys using tangential overlapping edges as it has been described hereinabove.

The removable fastening of the adjacent keys is carried out by tangential bolting internally to the structure of the key edges. In particular, at positions along the tangential overlap lined up at determined levels along the central axis of the key tool, tangential piercings are carried out on the inner surface or on the outer surface, through each of which an inner tapping of smaller diameter passes through the two edges facing two adjacent keys. A bolt is then introduced into the tangential piercing and is screwed through the tapping common to both keys, so as they are then secured to one another. When dismantling, the bolt head is accessible to the operator who can then release the bolt and separate the two adjacent keys. By repeating the same bolting and tapping mounting on various levels along the central axis of the key tool and on each tangential overlap of each pair of adjacent keys, a removable connection of the key which may be thus easily secured and separated results. Of course, a stud system passing through a tangential piercing with the same axis for the two key adjacent edges and tightened by means of nuts on the two threaded ends of the stud is also provided.

In another form, each key, or the keys which must be displaced during the handling of the key tool, is endowed with a securing means to a complex system for automatic connection and handling of the keys. Such system for automatic connection and handling of the keys may include one or more robotic arm(s) which are controlled so as to maintain the connection between the keys on their tangential overlaps for the duration of use operations of the key tool such as the compaction of the folds of the perform of technical fabric, and such as the polymerization during impregnation of the compacted preform and folded by a thermoformable resin. The robotic arm(s) are also controlled to separate the keys of the key tool after each one of its uses and to drive the mobilized key to a determined rest position.

The solution provided by the new technique of tangential overlap of the adjacent edges of keys is to return the sealing of the key tool on a face parallel to the mold lines in order to have a sealing by crush and not by lateral contact with a management of front bladder setting up either:
by at least one inner partial bladder associated with a bladder external to the tool;
by a bladder external to the tool only.

According to a first concept of application of the key tool, the present disclosure comprises the application of at least one inner partial bladder associated with a bladder external to the tool so as to:
carry out a flat junction between keys in order to have a frontal interface;
integrate a seal between keys to carry out at least the compactions without an inner bladder. Indeed, the compaction applies an intermediate compression during the manufacture of the panel for settling of the folds of the fabric preform previously installed in the key tool;
carry out at least one inner partial bladder covering at least one junction of two keys instead of an inner peripheral bladder covering all keys.

The advantages of the first concept of application of the key tool of the present disclosure are mainly that:
the frontal interface is more reliable thanks to a marked bearing for positioning between two keys versus the interface obtained by a connection by radial returns of the keys;
the risks of improperly setting up of the bladder is limited, and therefore the risks of breakage during the polymerization is limited;
the dismantling of the keys during the unmolding operation is facilitated;
the time required to pass within the key tool for operators is limited, so as the health and safety working conditions of the staff are greatly improved.

According to a second concept of application of the key tool, the present disclosure comprises the application of a single bladder external to the tool only, so as to:
carry out a flat junction between keys in order to have a frontal interface;
integrate a seal between keys to carry out the compactions and the polymerization without an inner bladder. Indeed, the compaction applies an intermediate compression during the manufacture of the panel for settling of the folds of the fabric preform previously installed in the key tool;
ensure a definition of the specific seal allowing a sealing continuity of the keys without having to seal by the inside of the tool.

The advantages of the second concept of application of the key tool of the present disclosure are mainly that:
the frontal interface is more reliable (marked bearing) for positioning between two keys than the connection by radial returns of the keys;
the risks of improperly setting up of the inner bladder are reduced;
the dismantling of the keys during the unmolding operation is facilitated;
the time required to pass into the mold for the operators is reduced.

As it has already been mentioned hereinabove, the technique of the present disclosure may equally be implemented inside or outside of the key tool. Thus, if it has been described solutions with one or more internal or inner partial bladders, it is then provided one single external or outer bladder, but which completely surrounds the outer surface of the key tool. It is expected to reverse the partial bladders by placing them outside of the key tool, becoming external or outer partial bladders and it is then disposed an internal or inner complete bladder.

Similarly, the connection means of the keys may be equally disposed on the inner surface or on the outer surface of the key tool.

The tool of the present disclosure is used to produce a composite panel, in particular for an aircraft engine nacelle. The panel, has a rotational symmetry which, during the manufacture is determined by the central axis of the key tool. The composite panel includes a preform of a technical textile such as carbon fibers, or Kevlar, in the form of a weaving which is then folded draped, shaped, compacted and impregnated with resin by using a key tool according to the previous description.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A key tool of a kind including at least two keys having adjacent edges, the tool having a substantially cylindrical shape with a central axis, the adjacent edges being substantially parallel to the central axis, wherein the adjacent edges have tangential overlaps relative to the inner and/or outer surface of the key tool.

2. The key tool according to claim 1, wherein the tangential overlap of two adjacent edges of keys includes a thinning of a first edge of an inner side of the tool facing a thinning of a second edge of an outer side of the tool so that an extra thickness is not introduced onto the inner and/or outer surface of the key tool.

3. The key tool according to claim 1, wherein the tangential overlapping portions of two adjacent edges cooperate with a seal.

4. The key tool according to claim 1, wherein at least one tangential overlap of adjacent edges of keys is covered by an inner and/or outer partial bladder, and two seals are substantially parallel to the central axis of the key tool and are disposed on both sides of said at least one tangential overlap between the inner and/or outer partial bladder and the inner and/or outer surface of the key tool.

5. The key tool according to claim 4, wherein an inner, respectively an outer partial bladder cooperates with an outer, respectively inner bladder by a return passing over an annular edge of the key tool and a lug coming into contact with a seal on a surface facing a counterpart portion of said outer, respectively inner bladder.

6. The key tool according to claim 5, wherein a seal is disposed on an annular edge of the key tool so as to seal an inner or outer partial bladder at its return passing over the annular edge of the key tool.

7. The key tool according to claim 1, wherein the key tool cooperates with at least one inner, respectively outer partial bladder and one outer, respectively inner complete bladder.

8. The key tool according to claim 1, wherein the key tool cooperates only with an outer, respectively inner complete bladder.

9. The key tool according to claim 1, wherein the keys are secured by bolt- or stud-type tangential connectors.

10. The key tool according to claim 1, wherein the keys are secured by an automatic connection system.

11. A composite panel, in particular for an aircraft engine nacelle, having a rotational symmetry, wherein the composite panel includes a folded draped preform, the preform being shaped, compacted and impregnated with resin by using a key tool according to claim 1.
